(19) United States
(12) Patent Application Publication
(10) Pub. No.: US 2008/0123584 A1
(43) Pub. Date: May 29, 2008

(54) Route Optimization for MultiHop Relay Transmission Systems

(75) Inventors: Michael Behrendt, Nuremberg (DE); Aik Chindapol, Washington, DC (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Corporate Research, Inc., Princeton, NJ (US)

(21) Appl. No.: 11/832,794

(22) Filed: Aug. 2, 2007

Related U.S. Application Data
(60) Provisional application No. 60/836,317, filed on Aug. 8, 2006.

(51) Int. Cl. H04B 7/14

(52) U.S. Cl. 370/315

(57) ABSTRACT

Methods and systems for multihop routing in wireless transmission are disclosed. Routing is initiated and grown from a Base Station by a Network Entry Process for Relays. A Route Report Messages structure is disclosed and a Route Maintenance Message structure and message sub-block structures are also disclosed. A Quality-of-Service model for multihop routing is also disclosed.

### CROSS-REFERENCE TO RELATED APPLICATIONS

This application claims the benefit of U.S. Provisional Application No. 60/836,317 filed Aug. 8, 2006, which is incorporated herein by reference.

### BACKGROUND OF THE INVENTION

The present invention relates to multi-hop networks.

Multi hop networks operate under a routing selection operation, and preferably include some type of routing optimization. Some approaches to these issues model the network as a graph and use metrics to define optimal routes. Other approaches have been suggested as well. None of the route selection and optimization methods provide a desired level of performance. Accordingly new methods and/or apparatus providing improved performance are required.

### SUMMARY OF THE INVENTION

The present invention provided improved route selection and route optimization capabilities in a multi-hopping network.

In accordance with one aspect of the present invention, a multihop routing method in a multi-hop network having a plurality of nodes including a Base Station (BS), a Mobile Station (MS) and at least one Relay Station (RS) is provided. The method includes executing a Network Entry Process for Relay Stations for growing the multihop network from a BS by applying Route Report messages and Route Maintenance messages that specify routing connections.

In accordance with a further aspect of the present invention, the method includes the step of starting with a first Base Station as the first node of the multihop network.

In accordance with further aspects of the present invention, the method can also include the steps of: entering a first RS with a relaying subsystem disabled into the multihop network and enabling a first RS relaying subsystem.

In accordance with further aspects of the present invention, the method can further include the steps of: discovering by the first RS its identifiable neighbors, including Mobile Stations and Relay Stations, reporting by the first RS to the BS in a Route Report message and reporting by the BS to all nodes in the network by a Route Maintenance message.

In accordance with further aspects of the present invention, the method can also include the steps of: identifying a second RS with switched off relaying subsystem by the first RS as a node in the network, enabling the relaying subsystem of the second RS, and reporting by the first RS to the BS in a Route Report message.

The method of the present invention can also provide reporting on a continuous basis by the first RS with a Route Report message of all available paths including quality information. In accordance with a further aspect of the BS reports to all nodes in a Route Maintenance message.

In accordance with another aspect of the present invention, a second RS can execute the steps of the first RS as previously set forth.

In accordance with other aspects of the present invention, a Route Report is sent by a RS to a BS on a dedicated connection. The Route Report can include a timestamp and a sequence number and a quality measure for a reported connection.

The BS can set up a routing and reporting of the routing in a Route Maintenance message by the BS. A Route Maintenance message can include a block structure having: a Relay ID field, a field identifying a number of sub-blocks, a field identifying a number of items in a Routing Table. It can also include a number of sub-blocks when the field identifying the number of sub-blocks is not zero and a Routing Table. A sub-block can have the same structure as the block structure.

The Routing Table can include: a CID, a Direction Indicator, an optional indicator providing a method of encoding and an optional indicator providing a method of modulation.

A system that performs the previously described steps is also provided in accordance with another aspect of the present invention.

### DESCRIPTION OF THE DRAWINGS

FIG. 1 provides a diagram with a classification of routing concepts.

FIG. 2 illustrates distance vector routing.

FIG. 3 illustrates link state routing

FIG. 4 provides a downlink routing matrix based on a network configuration.

FIG. 5 provides an uplink routing matrix based on a network configuration.

FIG. 6 illustrates a Relay Network Entry Step 1.

FIG. 7 illustrates a Relay Network Step 2.

FIG. 8 illustrates a Relay Network Step 3.

FIG. 9 illustrates a Route Report Message.

FIG. 10 illustrates a Route Maintenance Message.

FIG. 11 provides a Route Maintenance Example.

FIG. 12 provides a spanning tree and possible connections for a single station downlink.

FIG. 13 provides a spanning tree and possible connections for a single station uplink.

FIG. 14 provides a spanning tree and possible connection graph for a 100 station downlink.

FIG. 15 provides a spanning tree for a 100 station downlink.

FIG. 16 provides a spanning tree and possible connection graph for a 100 station uplink.

FIG. 17 provides a spanning tree for a 100 station uplink.

FIG. 18 provides a spanning tree for 3 hops, 150 stations downlink.

FIG. 19 provides a spanning tree for 3 hops, 150 stations downlink.

### DESCRIPTION OF A PREFERRED EMBODIMENT

Several aspects of the present invention are related to routing of data in a communication network. The following table shows the elementary design of a routing device.

| ROUTING DEVICE | | | FUNCTION |
|---|---|---|---|
| Routing Algorithm | | | Decision Process |
| Routing Protocol | | | Exchanged Messages |
| Link | Link | Link | Connection between Devices |

Routing is usually done on every network device, which is able to forward data and has at least two different links to other members of the network. It is important to note the difference between the algorithm and the protocol. Several protocols are using the same algorithm. The job of an algorithm is to calculate the solution, but the job of a protocol is to transport the required data by using messages. These are exchanged between the different routing devices in addition to the usual data traffic.

The solution to the routing problem is provided by graph theory. This is quite straightforward, because every computer network can be drawn as a graph. The computers (or routers) are the nodes and the connections (or links) are the edges inside the graph.

Either directed or undirected edges can be used. In the first case, there is a symmetric connection between the participants. Sometimes it is useful to model the connection between the participants as asymmetric. An example would be different up-link and down-link throughput which are quite often used in cable or DSL modems. An introduction into the used algorithms and the required proofs is given by T. H. Cormen. Introduction to Algorithms, Second Edition, The MIT Press, 2001. Several of the concepts applied to the aspects of the present invention are described in the cited book.

Single-Source Shortest Path Problem

For a transmission, a member of a network requires a path to be used to another member. Using the language of graph theory, this is called a “Single-Source Shortest Path” problem, where loop-free paths to all possible destinations are calculated at the same time. Theoretically every possible path could be used, but in practice it should be optimized. Graph theory is using weighted edges for modeling this requirement. This weight is a cost, which is a quality measurement for this edge. The goal of the optimization is to find a path with minimized cost. For this reason the problem is a special form of a linear program with the path minimization as objective function.

There are two algorithms with quite similar performance available, which will solve this problem. The first one is the Bellman-Ford algorithm. The best possible implementation is Q(VE). The advantage here is that non negative weights are allowed. Details are described in T. H. Cormen. Introduction to Algorithms, Second Edition, The MIT Press, 2001, section 24.1. The second algorithm is the Dijkstra algorithm. With the assumption, that weights are always non-negative, a faster algorithm is available. It's best implementation is O(E+V log V). Details are described in T. H. Cormen. Introduction to Algorithms, Second Edition, The MIT Press, 2001, section 24.3 and in R. Perlman. Interconnections Second Edition, Bridges, Routers, Switches, and Internetworking Procotols. Addision-Wesley Professional Computing Series, 1999. Penman, page 317ff.

Cost of a Link

For demonstration purposes, the cost or weight of a link is usually a fixed number (often “1”) and are equal for every edge. The resulting length of the shortest path is the lowest number of nodes, which have to be passed when going straight to the target. This concept is called Shortest Path First (SPF) Metric in the routing language. From the point of view of graph theory, different costs are equal to different distances between towns. In this case, the number of towns to pass is irrelevant, only the shortest total distance is preferred. This idea is used in further routing metrics.

Concepts of Wired Routing Protocols

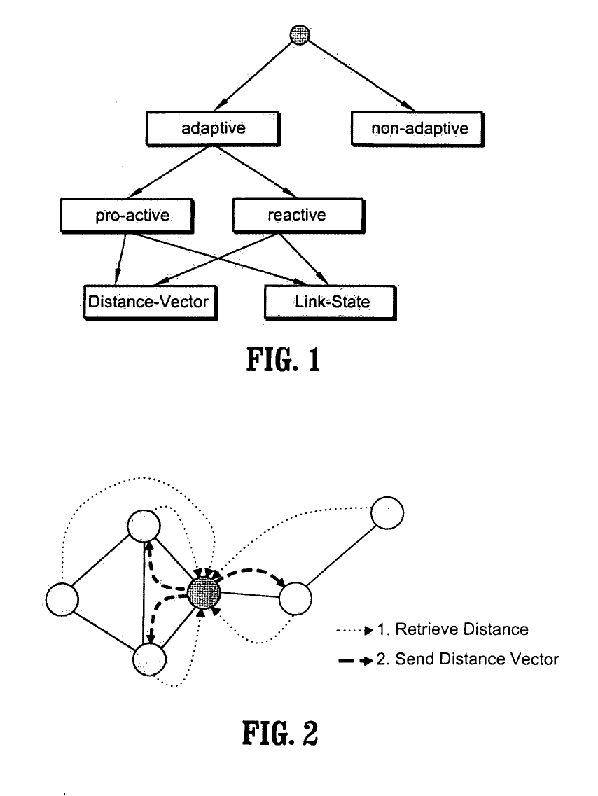

Routing was originally developed for wired connections. Later it was extended by the special needs of wireless connections. This explains why the original classification only regards the wired protocols. The algorithms identified previously are usually implemented as a distributed system. Here several computers are participating in the calculation of the result, by comparing different paths. If only one computer is comparing every possible path, then it is a centralized implementation. A distributed system has to agree on a certain organization. There are several strategies available. Every wired routing protocol can be classified by the following criteria: adaptive or non-adaptive; pro-active or reactive; Distance-Vector or Link-State. The relationships between these criteria are shown in FIG. 1 and are explained hereafter.

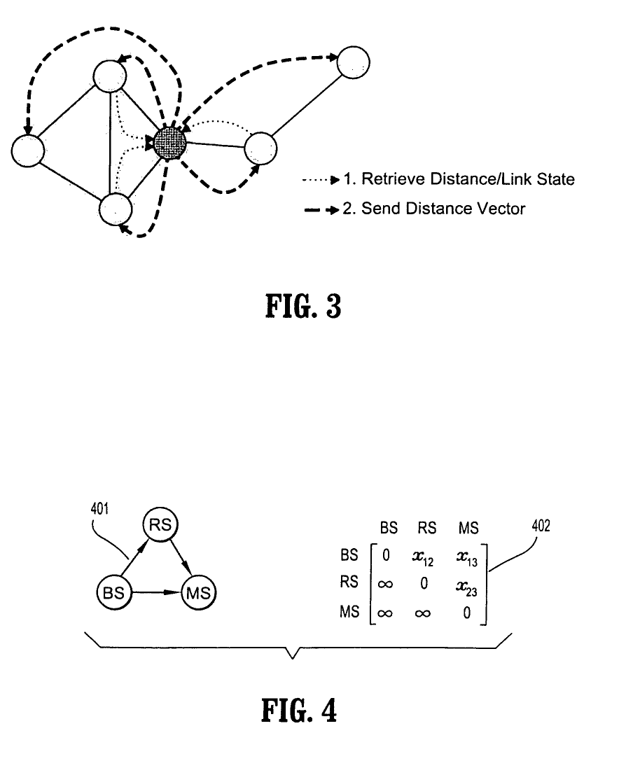

Non-adaptive systems are using fixed routing tables, which are manually maintained. For this reason they don't allow addition or removal of stations during run-time. Adaptive systems are using a routing protocol to dynamically adapt changes to the paths between stations. Reactive systems don't prepare any routes in advance. The advantage is that they remain silent on the network, until a route is requested. The disadvantage is the delay in the connection setup, until the route is discovered by a flood message. Pro-active systems maintain routing tables for every destination in advance. For this reason they are also sometimes called table-driven protocols. The pros and cons are opposite to reactive systems. Distance-Vector systems are first receiving the distances from all nodes and will then tell their neighbors about their distances to each node. FIG. 2 provides a diagram of Distance Vector Routing. Link-State-Routing systems are first receiving the distance to their neighbors or in other words, the distance of each link. Afterward they are broadcasting their distances in the whole network FIG. 3 provides a diagram of Link State Routing.

Comparison Distance-Vector vs. Link-State-Routing

In R. Perlman. Interconnections Second Edition, Bridges, Routers, Switches, and Internetworking Procotols. Addision-Wesley Professional Computing Series, 1999, section 12.1.1, Perlman is reporting about the “count to infinity” problem and slow convergence speed in Distance-Vector routing. The “count to infinity” situation will result in an endless loop during the route selection process. In section 12.3 Perlman adds furthermore, that “convergence is the truly critical point”. For this reason Link-State-Routing should be preferred.

### Source-Routing

Source-Routing is a third concept, besides Distance-Vector and Link-State Routing. The main idea is, to include a path inside the packet header, which is modified by each hop, which will forward the package. For a Route Discovery, a node is sending a Route Discovery Package including the target ID to each of its neighbors, which will add their ID in the package header, before they forward it again to each of their neighbors. Loops can be discovered by a node by inspecting the source path for its own ID. When the package arrives at the target, the package header contains a valid path to the source node. Usually several Route Discovery Packets will arrive at the target, each with different paths. The target has to reply with a Route Identification Packet, which is sent along the preferred path.

Advanced Concepts of Wireless Routing

Wireless routing introduced the idea of an ad hoc or mesh network, where every participation station is a network client and a router at the same time. Protocols for such self organizing networks could be classified by the additional criteria, which are provided hereafter.

Mobility and Convergence Speed

Routers are usually at fixed places in the wired world. The mobility in the wireless world is introducing a new performance factor, namely the convergence speed. This is the time, which is required by the routing protocol, to adapt the whole routing to the new locations of the stations.

Multicast Routing on Broadcast Media

Furthermore wireless routing protocols can adapt the broadcast nature of radio transmissions for multicast. In contrast to a wired world, where multicasts have to be replicated at several ports, this is not necessary in the wireless case. However not every wireless routing protocol is taking advantage of this benefit.

Common Case Traffic

Only some routing protocols are assuming a non homogenous traffic distribution. Usually there is a special node inside the wireless network, that acts as a gateway e.g. to the Internet. Therefore the traffic is increasing very much, if the distance to this gateway is becoming smaller. This will cause several congestion problems, if the routing is via a low throughput link close to the gateway.

Existing Routing Solutions

The common routing technologies are using a distributed algorithm implementations, because there shouldn't be any central point of failure. To stay independent of the OSI media access layer 2, they are implemented inside layer 3.

Wired Routing for IEEE 802.3 Systems

Example for Distance Vector Routing: RIP. According to R. Perlman. Interconnections Second Edition, Bridges, Routers, Switches, and Internetworking Procotols. Addision-Wesley Professional Computing Series, 1999, section 14.2 the Routing Information Protocol (RIP) is using only two packet types: one for requests and another one for responses. A response can either be triggered by a periodic timer, a request or an update of a cost.

Command requests

IP address

Command responses

IP address (repeated for multiple responses inside one packet)

metric (repeated for multiple responses inside one packet)

Example for Link State Routing: OSPF

In R. Perlman. Interconnections Second Edition, Bridges, Routers, Switches, and Internetworking Procotols. Addision-Wesley Professional Computing Series, 1999, section 14.4.10 Perlman briefly describes the packages of Open Shortest Path First (OSPF). The following list is a summarizing of the content.

Hello Packets between neighbors

Database Description Packets

Link State Request, Link State Update, Link State Acknowledgment

Link State Advertisement (Router, Network, Summary, AS External)

unique Node-ID

List of directly connected neighbors

Sequence number

TTL

Hello Packets are useful to introduce neighbor routers to each other. The Database Description Packets will be used to dump the whole routing database from one memory to another. This will speed-up the network entry process and avoids additional communication overhead. Request, Update and Acknowledgment are for managing the advertisements. Finally the advertisements contain the required information for the route calculation.

Wireless Routing for IEEE 802.11 Systems

The following major protocols are available for mesh routing in 802.11 systems. They commonly use the Shortest Path First Metric. Furthermore there are usually real-world implementations available. Advanced protocols may be using more improved ideas. For example, advanced protocols could comprise a combination of different strategies or using a different routing metric.

Highly Dynamic Destination-Sequenced Distance-Vector Protocol (DSDV)

The DSDV protocol described in C. Perkins and P. Bhagwat, “Highly dynamic destination-sequenced distance-vector routing,” 1994 was one of the first protocols for mesh routing. Like its wired RIP protocol example, it uses a reactive Distance-Vector approach. Furthermore it applies sequence numbers to fix the “count to infinity” problem.

Ad Hoc On-Demand Distance Vector (AODV)

The AODV protocol was published by Perkins in C. Perkins, “Ad hoc on demand distance vector (aodv) routing,” 1997. AODV is a Distance-Vector protocol, which is using a reactive strategy. It relies on source and destination sequence numbers to eliminate the count-to-infinity Distance-Vector problem and ensures loop-free behavior at every time. It comprises the following elements:

Route Request

Hop Count

Broadcast ID

Destination IP Address

Destination Sequence Number

Source IP Address

Source Sequence Number

Route Reply

Hop Count

Destination IP Address

Destination Sequence Number

Source if Address

Lifetime

This protocol is also capable of multicast routing. It even includes simple Quality-of-Service (QoS) support for maximum delay and minimum bandwidth constraints.

Dynamic Source Routing (DSR)

In D. B. Johnson and D. A. Maltz, “Dynamic source routing in ad hoc wireless networks,” 1996, the authors describe the Dynamic Source Routing.

Open Link State Routing (OLSR)

The OLSR is a pro-active Link-State-Routing protocol, which is described in T. Clausen, P. J. (editors), C. Adjih, A. Laouiti, P. Minet, P. Muhlethaler, A. Qayyum, and L. Viennot, “Optimized link state routing protocol (olsr),” RFC 3626, October 2003. It introduces Multipoint Relays (MPRs) for improving the flooding of the network with command messages. A MPR is regular node, which was selected by the OLSR protocol. The protocol uses three groups of messages:

HELLO

### This message is used for link sensing and neighborhood detection

MID

### Multiple Interface Declarations are used e.g. for declaring hosts outside the network

TC

Topology Control Messages are reporting the neighborhood of one node to the network. For this reason they are using following field structure:

Advertised Neighbor Sequence Number

### The sequence number is important to determine outdated messages.

List with Advertised Neighbor Main Addresses

### This is the unique IDs set of the neighbors.

Performance Comparison

A performance comparison of DSR, Temporally-Ordered-Routing Algorithm (TORA), DSDV, and AODV is provided in J. Broch, D. A. Maltz, D. B. Johnson, Y.-C. Hu, and J. Jetcheva, “A performance comparison of multi-hop wireless ad hoc network routing protocols,” in Mobile Computing and Networking, pages 85-97, 1998. Especially in mobility situation, DSR and AODV are outperforming DSDV. In J. J. Garcia-Luna-Aceves and M. Spohn, “Transmission-efficient routing in wireless networks using link-state information,” Mobile Networks and Applications, 6(3):223-238, 2001, it is shown trough simulation experiments, that Source-tree adaptive routing (STAR) will outperform DSR.

Advanced Routing Metrics

In D. S. J. De Couto, D. Aguayo, B. A. Chambers, and R. Morris, “Performance of multihop wireless networks: Shortest path is not enough,” in Proceedings of the First Workshop on Hot Topics in Networks (HotNets-I), Princeton, N.J., October 2002. ACM SIGCOMM, experiences with wireless routing are provided. For the tests described in the cited article, two wireless test beds and different wireless routing protocols are used. Often minimum hop-count routes are chosen, which are problematic because of too many retransmissions due to bad signal quality. Therefore it was suggested to pay more attention to link quality. Several papers exist that describe attempts for providing routing costs. These are shown in the following table for an overview.

| Metric | Throughput | PER | Interference | Cost Value |
|---|---|---|---|---|
| MTM [1] | yes | — | — | transmission time |
| ETX [5] | — | yes | — | expected number of transmissions |
| WCETT [7] | yes | yes | — | $ETT = ETX \frac{Packet Size}{Throughput}$ |
| MRS [10] | yes | yes | yes | Distance Vector = <Transmission Rate, |
| | | | | Opt. Power, Interference, PER> |

The above table refers to the following publications:
MTM [1]=B. Awerbuch, D. Holmer, and H. Rubens. High throughput route selection in multi-rate ad hoc wireless networks, 2003.
ETX [5]=D. S. J. D. Couto, D. Aguayo, J. Bicket, and R. Morris. A high-throughput path metric for multi-hop wireless routing. In MobiCom '03: Proceedings of the 9th annual international conference on Mobile computing and networking, pages 134-146, New York, N.Y., USA, 2003. ACM Press. ISBN 1-58113-753-2.
WCETT [7]=R. Draves, J. Padhye, and B. Zill. Routing in multi-radio, multi-hop wireless mesh networks. In MobiCom '04: Proceedings of the 10th annual international conference on Mobile computing and networking, pages 114-128, New York, N.Y., USA, 2004. ACM Press. ISBN 1-58113-868-7.
MRS [10]=L. Iannone and S. Fdida. Mrs: a simple cross-layer heuristic to improve throughput capacity in wireless mesh networks. In CoNEXT '05: Proceedings of the 2005 ACM conference on Emerging network experiment and technology, pages 21-30, New York, N.Y., USA, 2005. ACM Press. ISBN 1-59593-197-X.
   PER means Packet Error Rate. These metric are replacing the Shortest Path First Metric by improving the cost values.

Wireless Routing for HiperLAN/2

HiperLAN/2 is another wireless transmission system with centralized bandwidth management. Similar to IEEE 802.16 systems, relays should help to increase the total throughput. There are several papers available which describe the routing decisions in these systems: a first one S. Mengesha and H. Karl, “Relay routing and scheduling for capacity improvement in cellular wlans, 2003,” and a second one: A. Vaios, K. Oikonomou, and I. Stavrakakis, “A centralized routing scheme supporting ad hoc networking in dual mode hiperlan/2,” 2003. Both articles use Signal to Interference plus Noise Ratio (SINR) based information about throughput to compare two links.

Routing in IEEE 802.16, Concept and Algorithm

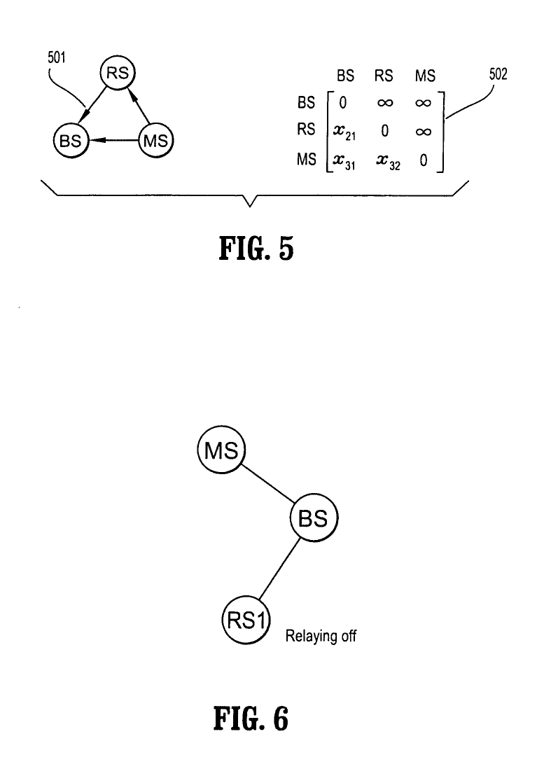

Like in every other routing model, the Dijkstra Algorithm will be used to setup a tree with the shortest paths. This algorithm requires a connection matrix, which contains every possible connection in the system and the assigned cost for using it. FIG. 4 shows a connection diagram 401 and the according matrix 402 for downlink and FIG. 5 shows a connection diagram 501 and according matrix 502 for uplink. Herein BS is Base-Station, RS is Relay Station and MS is Mobile Station. The algorithm will find the way from a specified station to each other station with regard to an optimization criterion. In the case of multiple relay stations for at least 3 hops, the matrix has to be extended by additional non-zero columns and rows, which will allow an RS to RS routing. The optimization goal was to minimize the transmission time, like suggested in B. Awerbuch, D. Holmer, and H. Rubens, “High throughput route selection in multi-rate ad hoc wireless networks.”, 2003, wherein the Medium-Time-Metric was introduced. The following cost table according to the scheme previously described.

| Modulation/ | Minimal | Bits per | Minimization | Cost Value |
|---|---|---|---|---|
| Coding Rate | SINR | Symbol | Problem c | c′ = (int)c * 1000 |
| — | 0 | — | — | ∞ |
| PSK ½ | 6.4 | 1 | 1/1 | 1000 |
| QPSK ½ | 9.4 | 1.5 | 1/1.5 | 666 |
| QPSK ¾ | 11.2 | 2 | 1/2 | 500 |
| 16 QAM ½ | 16.4 | 3 | 1/3 | 333 |
| 16 QAM ¾ | 18.2 | 4 | 1/4 | 250 |
| 64 QAM ⅔ | 22.7 | 4.5 | 1/4.5 | 222 |

The values of the minimal Signal-to-Noise Ratio (SNR) are from C. Hoymann, “Analysis and performance evaluation of the ofdm-based metropolitan area network IEEE 802.16.”, Computer Networks, Selected Papers from the European Wireless 2004 Conference, 49(3):341-363, October 2005, Table 3.

Routing Protocol

For collecting the required Dijkstra input data, communication in the network is necessary. A routing protocol will be provided as an aspect of the present invention, which is adapted to the special needs of IEEE 802.16. Existing routing protocols are implemented inside OSI layer 3. In the present case of wireless routing it is much more straightforward, to integrate the protocol inside IEEE 802.16 and OSI layer 2, which is unusual, but not impossible. It has the advantage of transparency to the higher layers and avoids modifications to the protocols residing in the higher layers. The following list is a collection of assumptions, which are necessary for the described protocol:

A unique relay dedicated connection such as a management connection used in IEEE 802.16 between each RS and BS is available

The relay dedicated connection is routed through the existing network, at least in the 3 hop case.

RS to RS communication is possible, at least in the 3 hop case.

Broadcasts are repeated, if coverage extension is required.

No communication without bandwidth management by the BS is possible.

### Conclusion: The network has to grow starting from the BS.

Network Entry Process for Relays

One of the core components of IEEE 802.16 is the centralized bandwidth management by the base station. For this reason, the base station has always to be included in the network. The simplest network is the BS alone, which is extended step-by-step by additional neighborhoods. Each of them will form another network hop. In detail this process is:

### 1. Network with only one root node, which is the base station.

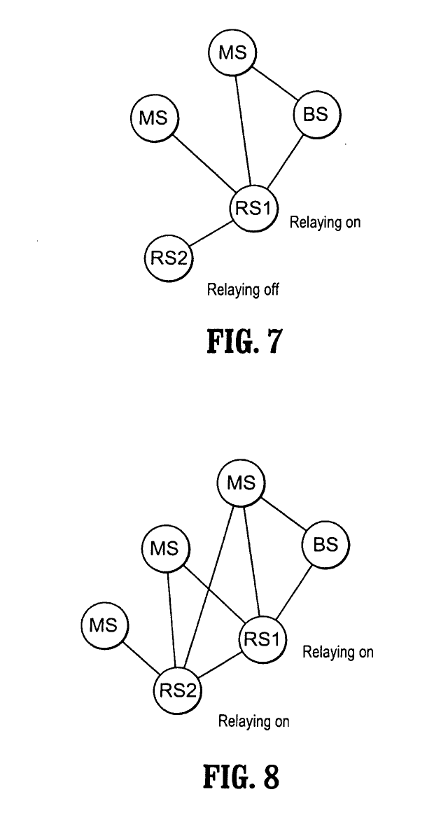

2. The MS in transmission range to the BS will follow the regular network entry process. RS close to the BS will also enter the network by the regular process, but their relaying subsystem is turned off at this time. Therefore they behave as “usual” MS as shown in FIG. 6 as a diagram of Relay Network Entry Step 1. Furthermore the relay station will open its relay dedicated connection and exchange capabilities. Afterward it will turn on its relaying subsystem, which will lead to the next step.
3. The RS1 has discovered three new neighbors as shown in FIG. 7 as a diagram of Relay Network Entry Step 2. The first is the previous mobile station, an additional mobile station outside the transmission range of the BS and another RS, which cannot transmit directly too. This RS2 has its relaying turned off, so it acts as a usual mobile station.
(a) RS1 will report possible routings to the BS via its relay dedicated connection such as a management connection in a Route Report message.
(b) The BS will reply with a Route Maintenance message to the whole network, which will setup the routes for the new MS and RS2. Furthermore it might change the routing for the first mobile station to include the freshly discovered paths.
(c) RS1 is updating the possible path list, by sending Route Report messages regularly. All available routes are reported, with updated quality information. If a path is not available any more, it is not included in the report and the BS will answer with an updated Route Maintenance message.
(d) The established routing enables RS2 to open its dedicated connections, i.e., management connections, and to turn on its relaying subsystem.
4. In FIG. 8 as a diagram of Relay Network Entry Step 3 the RS2 has discovered more possible paths, which will form a 3 hop network. RS2 will follow the same procedure as RS1 from the previous step.

Route Report

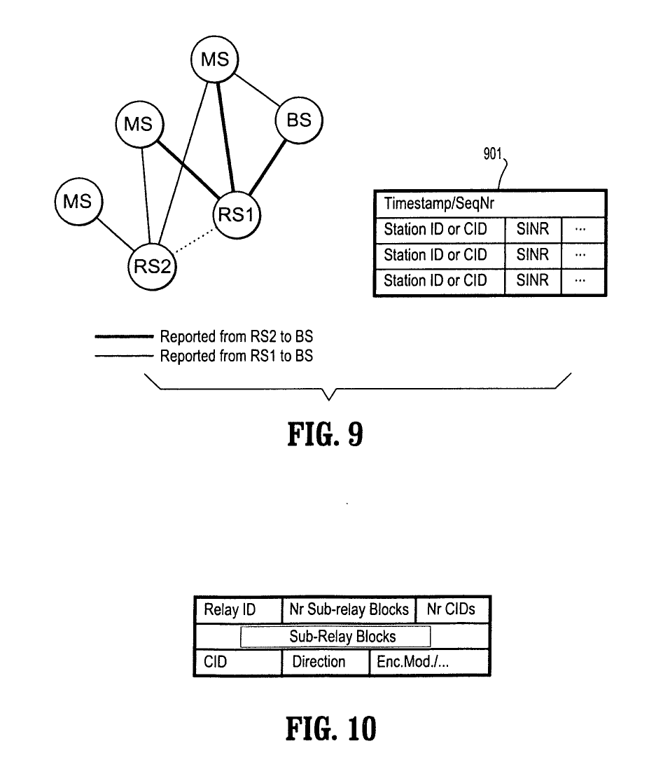

A Route Report message is sent by each relay to the base station via the according dedicated such as a management connection used in IEEE 802.16 connection. Its contents are illustrated in table 901 of FIG. 9. The timestamp or sequence number is used to avoid overwriting of newer information at the BS by outdated packets, which might arrive delayed for various reasons. Afterwards there is a list with one item for each connection at the according node. Each item of the list should contain the SINR or other measured values, which are requested through the capability exchange. For this reason a flexible encoding like the type-length-value (TLV) should be used. Duplicate reports are possible, i.e., the connection between RS1 and RS2, which is reported by both relays.

Route Maintenance

The BS will setup the routing for each connection and will summarize the results in a Route Maintenance message. Different connections, with the same source and target, could use different paths, because of for instance QoS requirements. Therefore the usage of stations IDs like 48-bit MAC addresses is not possible. Instead Connection Identifiers (CIDs) are used. In theory, the BS could send individually a routing table for each relay via the relay dedicated or management connection. This would increase the number of overhead packages and for at least 3 hop scenarios, some data would be transmitted twice.

The other solution is to broadcast one recursive structure, which contains the whole tree at the same time. This will avoid the duplicate transmission of routing data in the at least 3 hop scenario. In the use case of coverage extension, it is assumed that the broadcast will be replicated to cover the whole area of a cell.

FIG. 10 illustrates the to be used data structure. To become a tree it is a recursive structure which will contain several further instances inside itself. The first field in the first row of the structure as provided in FIG. 10, the Relay ID, is necessary for the relay station to identify the according part of the message. Here, the Relay ID, in the context of IEEE 802.16, could be the CID that uniquely identifies each individual relay station. Next there are two counters, by which the length of the whole message could be determined for easier message parsing. The first counter provides the number of recursive sub-blocks contained in this instance. The second counter is the number of items in the CID routing table, which is following after the sub-blocks. It is important to recognize, that a relay has to forward CIDs from its own routing table merged with the CIDs from the sub-blocks, because of the sub-tree.

The routing table of FIG. 10 contains the CID, a direction indicator and optionally information about the to be used encoding and modulations. If necessary, more fields may be added. The direction indicator is necessary, because CIDs for MAC management connections are equal in up- and down link according to the IEEE 802.16 standard. Only for data connections, they are different.

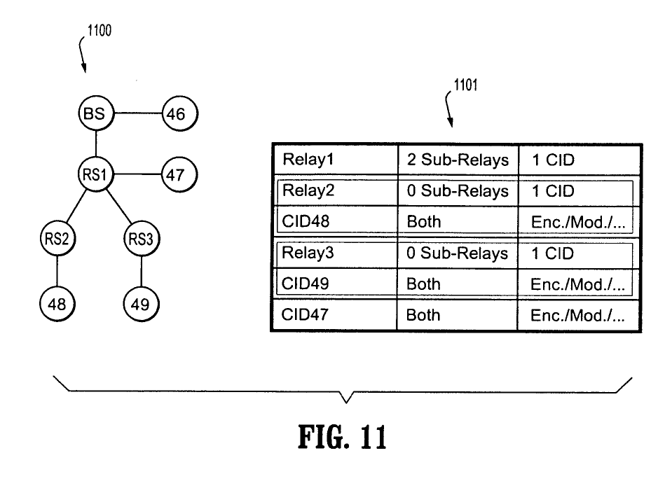

FIG. 11 shows an example for the data structure here provided in a diagram 1100 and a table 1101. The outer block in 1101 is for RS1. It comprises two sub-blocks and one element in the routing table. Besides this one element, the relay still has to forward CIDs 47, 48 and 49, because there are inside the sub-blocks. The first sub-block is for RS2 and doesn't comprise any further sub-blocks. For this reason the sub-block counter is zero and the according space is empty. RS3 is quite similar. The CID 46, which is directly connected to the BS, is not mentioned in the message at all. The reason is that it does not have to be processed by any relay. The simulation from section 3.2 shows, that a direct connection is preferred for most of the stations. Not to mention them, will save space inside the message.

### Illustrating Examples

A simulation was created to put the routing algorithm into the context of IEEE 802.16 and to visualize its output. In simulations, the necessary data structures are created to randomly place mobile stations inside a predefined area. Next the connection matrix is filled by looking up the cost values according to the path loss model. Afterwards the Spanning Tree for down link is calculated and outputted for visualization. Routing in down- and uplink could be different. For this reason the connection matrix is filled a second time with different uplink values.

Simulation Model

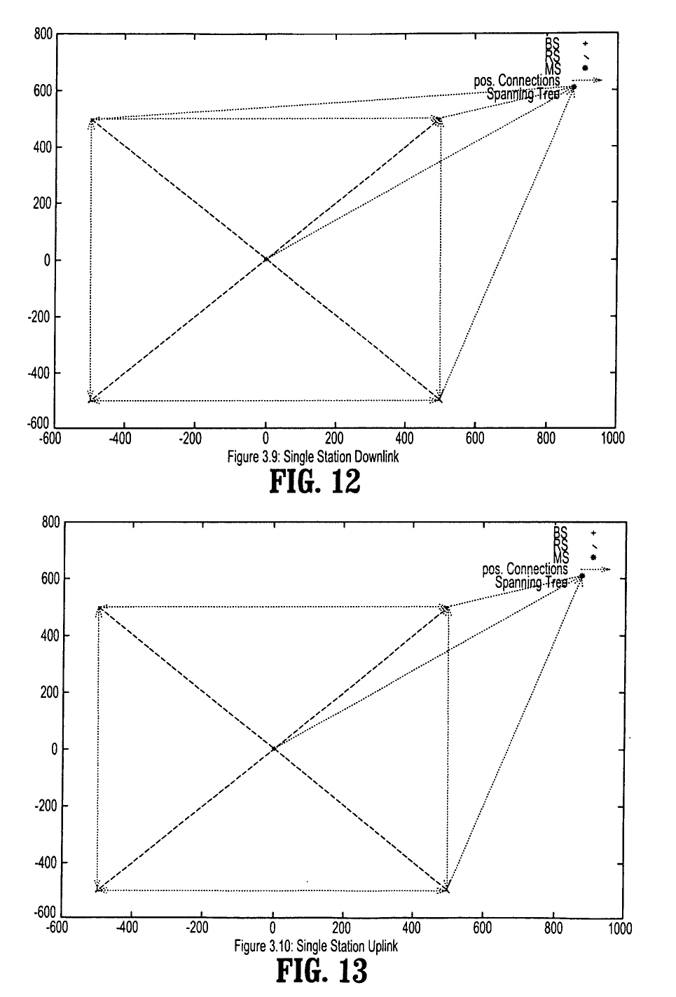

Stations: The base station of the model is located in the centre of the area. Four relay stations are placed in a square in the middle between base stations and area border. Furthermore the mobile stations are added with random coordinates. FIGS. 12 and 13 are showing examples with one mobile station. FIG. 12 is a diagram of a single station downlink. FIG. 13 is a diagram of a single station uplink.

Connections: The path loss model is using a target SINR at the maximum distance of:

10 dB when BS/RS is sending

5 dB when MS is sending

The maximum distance is from the origin to one of the area corners. This means that the BS could reach every other station in the downlink, at least with a robust encoding. This is equal to the requested use case of throughput enhancement. On the other side, mobile stations which are far away from the base station cannot directly connect, because of the much lower transmission power. Furthermore RS to RS connections, which are required for more than two hops are allowed.

Spanning Tree: Each picture comprises the resulting Spanning Tree. In the uplink a mobile station is only transmitting to the base station. For this reason, in this case only the part of the tree which is necessary to reach the base station is shown.

Results

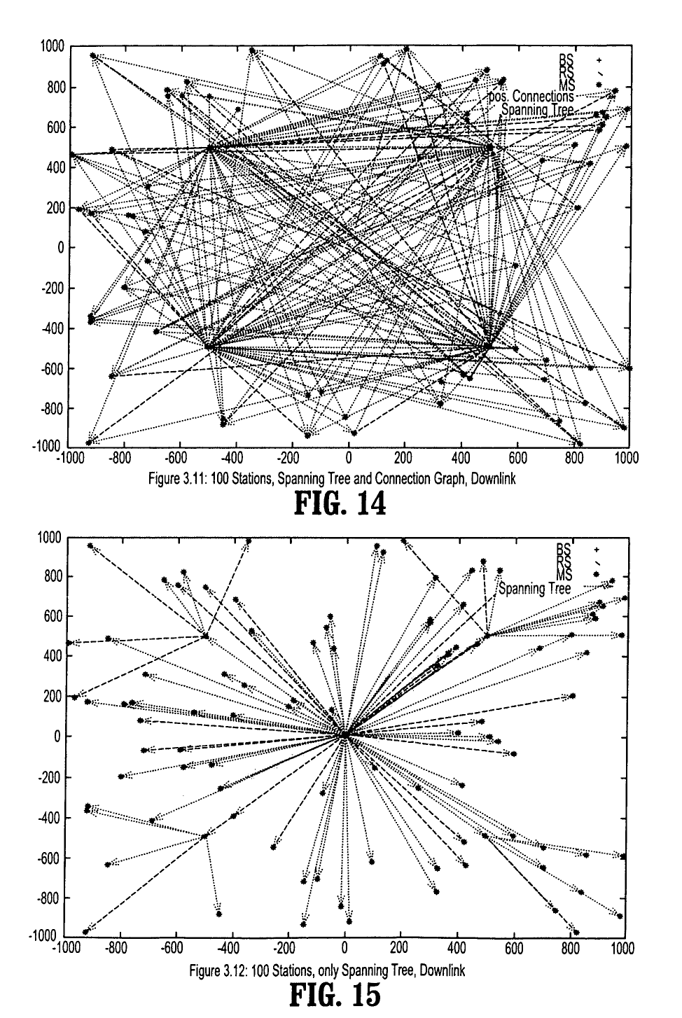

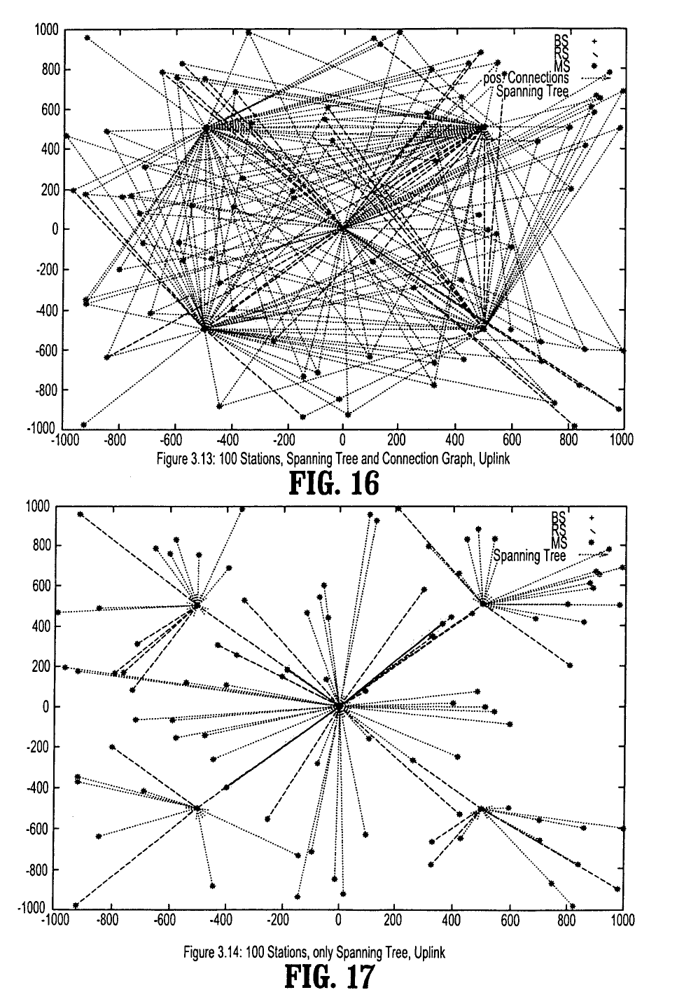

FIGS. 14 and 15 are diagrams of the downlink spanning tree. FIG. 14 comprises additionally every possible connection in the cell. FIGS. 16 and 17 are diagrams of the uplink for the same number of stations as in FIGS. 14 and 15. In the provided diagrams of FIGS. 14 to 17 it is possible to point out certain relayed and non-relayed areas. If for instance one compares some mobile stations nearby a relay station, one can discover different routing for down- and uplink.

Variations

3 Hops

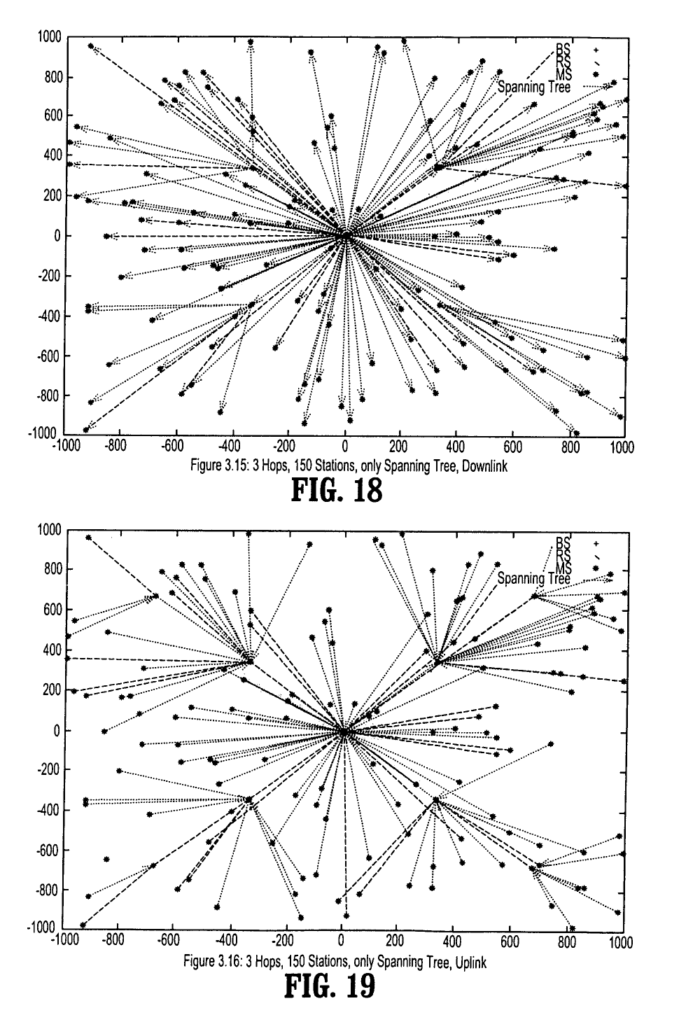

FIGS. 18 and 19 for down- and uplink are almost similar to the original model, besides now including eight relay stations. An unexpected result is that in the downlink the outer relay stations are not used at all. For the uplink the relays are still useful to avoid low throughput encodings.

Stronger SINR Between BS and RS

Furthermore the model was improved with a better signal for transmissions between BS-RS and RS-RS. The used target SINR for this group of connections is 15 dB. No changes to the routing were visible in the result.

Variations

3 Hops

FIGS. 18 and 19 for down- and uplink are almost similar to the original model, besides now including eight relay stations. An unexpected result is that in the downlink the outer relay stations are not used at all. For the uplink the relays are still useful to avoid low throughput encodings.

Stronger SINR Between BS and RS

Furthermore the model was improved with a better signal for transmissions between BS-RS and RS-RS. The used target SINR for this group of connections is 15 dB. No changes to the routing were visible in the result.

Improvements

QoS and Routing

The previous cost calculation for routing assumes that as much data as possible should be transported inside the whole cell at the same time. The following table provides an overview of the existing QoS scheduling services in IEEE 802.16.

| | | rtPS | nrtPS | |
|---|---|---|---|---|
| | UGS | real-time | non-real time | |
| | unsolicited | polling | polling | BE |
| QoS Class | grant service | service | service | best effort |
| Content | fixed-size | var-sized | var-sized | no minimum |
| | data packets | data packets | data | service level |
| | at periodic | at periodic | packets | |
| | intervals | intervals | | |
| Use Case | VoIP | MPEG video | FTP | — |
| | | | download | |
| Max. Sustained | Yes (=min) | Yes | Yes | Yes |
| Traffic Rate | | | | |
| Min. Reserved | Yes (=max) | Yes | Yes | No |
| Traffic Rate | | | | |
| Maximum | Yes | Yes | No | No |
| Latency | | | | |

The table can be compacted to the following cases:

### 1. No constraints

### 2. Minimum Reserved Traffic Rate only

### 3. Minimum Reserved Traffic Rate and Maximum Latency

When a connection requires certain constraints by its QoS profile, the optimization goal has to be changed. This variation will only affect this single connection and not the other ones.

Minimum Reserved Traffic Rate Constraint

A goal is this case should be to find the path with the maximum traffic rate. When the maximum possible traffic rate is lower than the minimal required one, then it is known that there is no path available. Otherwise the connection should be established using a path meeting, even if it would violate the previous optimization goal.

Maximum Latency Constraint

The calculation of the maximum latency is quite straightforward when a relay has to wait for the next frame until it can retransmit the data. In this case the relaying latency is calculated by number of hops times frame interval. The internal table data structure of the Dijkstra algorithm can be easily extended by an additional field, which will store the current number of hops for the to be probed path. Furthermore the relax condition of the algorithm has to be extended to:

1. Check if the delay constraint is violated. If that is the case, the currently probed sub-path is abandoned.

### 2. Maintain the hop field, by increasing it by one when another sub-path is added.

Combined Routing and Bandwidth Grand Messages

An IEEE 802.16 relay needs actually two information items for retransmitting:

Routing

The routing tells the relay what to repeat. This is the Route Maintenance message from an earlier section.

Bandwidth Assignment

The bandwidth assignment tells the relay when to repeat or listen. This assignment is contained in the Uplink/Downlink (UL/DL)-Maps.
For the bandwidth scheduling several models can be provided. In a first model, the relay station will schedule the UL-/DL-maps by itself. It will use time slots, which were delegated from the base station to the relay. Therefore the base station still has the control over the total time, which is delegated to the relay. In that case, the routing information needs to be transmitted separately.

In a second model when both bandwidth and routing information are distributed by the base station alone, then another possibility is possible, by unifying the currently separately transmitted routing and bandwidth assignment information.

In accordance with one aspect of the present invention a routing system for multihop relay transmission in a WiMax wireless network is provided. Relevant nodes such as relay stations and a base station in the network have capabilities either by computer programs running on processors or by electronic circuits for:

identifying neighboring nodes,
including neighboring relay nodes in a routing solution, and
reporting to a Base Station on the status of connections and nodes

Further more the Base Station has the capabilities, based on provided input by Relay Stations in for instance Route Report messages to create routing tables and inform Relay stations through Route Maintenance messages of a routing set-up including routing over multiple Relay Stations. As stated before certain conditions should be met, including a unique relay dedicated or management connection between each RS and the BS, even if an RS has its relaying function switched off.

Accordingly a system for multihop routing is provided.

The methods and systems of the present invention can be applied to any type of multi-hop networks.

The following references are generally descriptive of the background of the present invention and are hereby incorporated herein by reference: [1] B. Awerbuch, D. Holmer, and H. Rubens. High throughput route selection in multi-rate ad hoc wireless networks, 2003. [2] J. Broch, D. A. Maltz, D. B. Johnson, Y.-C. Hu, and J. Jetcheva. A performance comparison of multi-hop wireless ad hoc network routing protocols. In Mobile Computing and Networking, pages 85-97, 1998. [3] T. Clausen, P. J. (editors), C. Adjih, A. Laouiti, P. Minet, P. Muhlethaler, A. Qayyum, and L. Viennot. Optimized link state routing protocol (olsr). RFC 3626, October 2003. Network Working Group. [4] T. H. Cormen. Introduction to Algorithms, Second Edition. The MIT Press, 2001. [5] D. S. J. D. Couto, D. Aguayo, J. Bicket, and R. Morris. A high-throughput path metric for multi-hop wireless routing. In MobiCom '03: Proceedings of the 9th annual international conference on Mobile computing and networking, pages 134-146, New York, N.Y., USA, 2003. ACM Press. ISBN 1-58113-753-2. [6] D. S. J. De Couto, D. Aguayo, B. A. Chambers, and R. Morris. Performance of multihop wireless networks: Shortest path is not enough. In Proceedings of the First Workshop on Hot Topics in Networks (HotNets-I), Princeton, N.J., October 2002. ACM SIGCOMM. [7] R. Draves, J. Padhye, and B. Zill. Routing in multi-radio, multi-hop wireless mesh networks. In MobiCom '04: Proceedings of the 10th annual international conference on Mobile computing and networking, pages 114-128, New York, N.Y., USA, 2004. ACM Press. ISBN 1-58113-868-7. [8] J. J. Garcia-Luna-Aceves and M. Spohn. Transmission-efficient routing in wireless networks using link-state information. Mobile Networks and Applications, 6(3):223-238, 2001. [9] C. Hoymann. Analysis and performance evaluation of the ofdm-based metropolitan area network IEEE 802.16. Computer Networks, Selected Papers from the European Wireless 2004 Conference, 49(3):341-363, October 2005. [10] L. Iannone and S. Fdida. Mrs: a simple cross-layer heuristic to improve throughput capacity in wireless mesh networks. In CoNEXT '05: Proceedings of the 2005 ACM conference on Emerging network experiment and technology, pages 21-30, New York, N.Y., USA, 2005. ACM Press. ISBN 1-59593-197-X. [11] D. B. Johnson and D. A. Maltz. Dynamic source routing in ad hoc wireless networks, 1996. [12] S. Mengesha and H. Karl. Relay routing and scheduling for capacity improvement in cellular wlans, 2003. [13] C. Perkins. Ad hoc on demand distance vector (aodv) routing, 1997. [14] C. Perkins and P. Bhagwat. Highly dynamic destination-sequenced distance-vector routing, 1994. [15] R. Perlman. Interconnections Second Edition, Bridges, Routers, Switches, and Internetworking Procotols. Addision-Wesley Professional Computing Series, 1999. [16] A. Vaios, K. Oikonomou, and I. Stavrakakis. A centralized routing scheme supporting ad hoc networking in dual mode hiperlan/2, 2003; [17] IEEE Std 802.16e, IEEE Standard for Local and Metropolitan Area Networks, Part 16: Air Interface for Fixed and Mobile Broadband Wireless Access System, 2005; [18] IEEE Std 802.16, IEEE Standard for Local and Metropolitan Area Networks, Part 16: Air Interface for Fixed Broadband Wireless Access Systems, 2004.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A routing method in a multi-hop network having a plurality of nodes including a Base Station (BS), a Mobile Station (MS) and a Relay Station (RS) comprising executing a Network Entry Process for Relay Stations for growing the multihop network from the BS by applying Route Report messages containing measured information for a route calculation and Route Maintenance messages that specify routing connections.

2. The method as claimed in claim 1, further comprising the step of starting with the BS as the first node of the multihop network.

3. The method as claimed in claim 2, further comprising the steps:
entering the RS with a relaying subsystem disabled into the multihop network; and
enabling the relaying subsystem.

4. The method as claimed in claim 3, further comprising the steps:
discovering the RS's identifiable neighbors, including Mobile Stations and other Relay Stations;
reporting by the RS to the BS in a Route Report message; and
reporting by the BS to all nodes in the network by a Route Maintenance message.

5. The method as claimed in claim 4, further comprising the steps:
identifying a second RS with switched off relaying subsystem by the RS as a node in the network;
enabling the relaying subsystem of the second RS; and
reporting by the first RS to the BS in a Route Report message.

6. The method as claimed in claim 5, further comprising reporting on a continuous basis by the RS with a Route Report message of all available paths including quality information.

7. The method as claimed in claim 6, further comprising reporting by the BS to all nodes in a Route Maintenance message.

8. The method as claimed in claim 7, further comprising execution by the second RS of the steps of the first RS as claimed in previous claims and wherein the second RS is replaced by a third RS.

9. The method as claimed in claim 4, wherein a Route Report is sent by the RS to the BS on a dedicated connection.

10. The method as claimed in claim 9, wherein a Route Report comprises a timestamp or a unique sequence number or both, and a quality measure for a reported connection.

11. The method as claimed in claim 1, further comprising setting up of a routing and reporting of the routing in a Route Maintenance message by the BS.

12. The method as claimed in claim 11, wherein a Route Maintenance message comprises:
a block structure having one or more of the following:
a Relay ID field;
a field identifying a number of sub-blocks;
a field identifying a number of items in a Routing Table;
a number of sub-blocks when the field identifying the number of sub-blocks is not zero; and
a Routing Table.

13. The method as claimed in claim 12, wherein a sub-block has a same structure as the block structure.

14. The method as claimed in claim 12, wherein a Routing Table comprises one or more of the followings:
a CID;
a Direction Indicator;

15. The method as claimed in claim 12, wherein a Routing Table comprises one or more of the followings:
a CID;
a Direction Indicator;
an optional indicator providing a method of encoding; and
an optional indicator providing a method of modulation.

16. The method as claimed in claim 1, further comprising at least one MS and at least one RS executing the Network Entry Process.

17. A routing system for a multi-hop network comprising a plurality of nodes including a Base Station (BS), a Mobile Station (MS) and a first Relay Station (RS) and a second Relay Station comprising message generators for initiating and maintaining multihop connections wherein the network is initiated from the BS and the network is grown by the BS detecting the first Relay Station, the first Relay Station and the BS detecting the second Relay Station and the second Relay Station along with the first Relay Station and the BS repeating detecting a next Relay Station.

18. The system as claimed in claim 17, comprising detecting a next Relay Station and including the next Relay Station in the network by the BS sending a message to the next Relay Station and receiving a message from the next Relay Station.

19. The system as claimed in claim 17, further comprising a Relay Station detecting neighboring nodes including a Relay Station or a Mobile Station and reporting to the Base Station on the neighboring nodes in a message.

20. The system as claimed in claim 19, wherein the message includes all possible route paths from the Relay Station.
